(19) United States
(12) Patent Application Publication
(10) Pub. No.: US 2004/0201715 A1
(43) Pub. Date: Oct. 14, 2004

(54) Image recording apparatus

(75) Inventors: Toshiro Ishimura, Tokyo (JP); Mitsuo Obata, Tokyo (JP); Kouji Suzuki, Tokyo (JP)

Correspondence Address: Paul J. Esatto, Jr., Scully, Scott, Murphy & Presser, 400 Garden City Plaza, Garden City, NY, 11530, US

(73) Assignee: OLYMPUS OPTICAL CO., LTD., TOKYO (JP)

(21) Appl. No.: 09/817,926

(22) Filed: Mar. 27, 2001

(30) Foreign Application Priority Data
Mar. 28, 2000 (JP) 2000-089504
Feb. 23, 2001 (JP) 2001-048930

(51) Int. Cl. H04N 5/222; H04N 5/225

(52) U.S. Cl. 348/220.1; 348/333.01; 348/333.05

(57) ABSTRACT

An image recording apparatus has the ability to output one of a received motion image and a still image, which is selected by an image switching circuit, to an image display device. The still image is read from a memory in which an image of the motion image constructing one frame is stored. When a remote controller is used to instruct image recording, a recording mode is automatically determined depending on whether a still image or a motion image is actually displayed on the image display device. Specifically, when a still image is displayed, a still image recording mode is automatically selected. When a motion image is displayed, a motion image recording mode is automatically selected. The motion image or still image is then recorded onto a recording medium.

This application claims benefit of Japanese Application Nos. 2000-89504 filed in Japan on Mar. 28, 2000 and 2001-48930 filed in Japan on Feb. 23, 2001, the contents of which are incorporated by this reference.

### BACKGROUND OF THE INVENTION

### Description of the Related Art

The present invention relates to an image recording apparatus capable of recording an image in a plurality of recording modes including a still image recording mode and a motion image recording mode.

Conventionally, various types of image recording apparatuses have been proposed in efforts to enable recording of numerous image data items in a recording medium in the form of digital data, and to enable, if required, reproduction and display of the recorded image data.

The image recording apparatuses includes a type of image recording apparatus that can record image data, which is acquired during an endoscopic inspection performed using an industrial endoscope, by being used in combination with an industrial endoscope system.

Talking of an endoscopic inspection to be performed using an industrial endoscope, some objects of inspection must be inspected outdoor. For example, an inspection may have to be performed in a severe environment such as under scorching sunshine or during snowfall, or in a narrow space in which body motion is limited. In this case, if the inspection lasts for a prolonged period of time, an inspector must incur a heavy load.

The aforementioned image recording apparatus may be employed in an endoscopic inspection to be performed using the industrial endoscope. In this case, an inspector can concentrate on recording images with the image recording apparatus at an inspection site, and can closely analyze the images later at an office, to which the image recording apparatus is carried back, by taking much time. Consequently, the inspection time spent at the inspection site becomes shorter to reduce the load incurred by the inspector. Moreover, the images can be closely analyzed in a proper environment by taking much time. Missing a critical finding will therefore be avoided. For this reason, this is widely adopted.

Moreover, image data recorded with the image recording apparatus may be transferred to a personal computer or the like for the purpose of filing. This leads to simplified image management. Inclusion of the image recording apparatus provides the merit that the image data can be transferred to a remote place through the Internet.

U.S. Pat. No. 4,546,390 has disclosed a related art. The patent publication describes that discloses that a reading rate at which data is read from an imaging element is switched between a still mode and a movie mode. When data is read in the still mode, the data is recorded corresponding to all pixels. When data is read in the movie mode, the data is recorded with one of the number of pixels and the number of bits made smaller than that in the still mode.

However, in conventional image recording apparatuses including an image recording apparatus in accordance with this reference, whether a still image or a motion image(a motion picture) is recorded is designated by pre-setting an image recording mode using a switch or a menu.

For example, when an image is frozen, an image displayed on a display device is a still image. At this time, if the motion mode to which the image recording mode of the image recording apparatus is set is a motion image mode, the still image is recorded as a motion image.

However, when a still image is recorded as a motion image, the same image is kept recorded repeatedly. This therefore merely wastes an image storage area in a recording medium. In this case, an operator must suspend motion image recording, change the image recording mode to a still image mode, and resume still image recording.

When the recording mode of the image recording apparatus is set to the still image mode, if an object suitable for motion image recording appears, the recording mode must be switched from the still image mode to the motion image mode. Motion image recording must then started. Therefore, the image recording apparatus is unsuitable for a purpose of use for which the image recording modes must be switched in line with an object that comes along suddenly.

Moreover, an operator must memorize how image recording mode is set at present. When the operator is absorbed in an inspection, the operator may forget the current recording mode and therefore sometimes record an image in an unintended recording mode.

### SUMMARY OF THE INVENTION

An object of the present invention is to provide an image recording apparatus that is user-friendly and enables automatic recording in a recording mode suitable for the state of a displayed image.

Another object of the present invention is to provide an image recording apparatus capable of recording an image efficiently.

An image recording apparatus which comprises:

an image selecting circuit for selecting either of a motion image and a still image that are outputted;

a display device on which a motion image or a still image selected by the image selecting circuit is displayed;

a remote controller for use in instructing start of image recording;

a recording processing circuit for recording a motion image or a still image;

an image recording medium onto which an image is recorded by the recording processing circuit;

a recording control circuit for, when image recording from the remote controller is instructed, controlling to determine a recording mode, in which one of a motion image and a still image is recorded by the recording circuit, responsively to selection state of the image selecting circuit. When a user manipulates the remote controller, a recording mode is automatically determined so that if an image displayed on the display device is a motion image, the motion image can be recorded, or if the image displayed thereon is a still image, the still image can be recorded.

The above and other objects, features and advantages of the invention will become more apparent from the following description when taken in conjunction with the accompanying drawings.

### BRIEF DESCRIPTION OF THE DRAWINGS

FIG. 1 to FIG. 4 are concerned with a first embodiment of the present invention;

FIG. 1 is a block diagram of an image recording apparatus in accordance with the first embodiment of the present invention;

FIG. 2 is a block diagram showing the configuration of a video signal processing circuit and the configuration of a voice signal processing circuit;

FIG. 3 is a front view showing a remote controller;

FIG. 4 is a flowchart describing the steps of processing to be performed when an image recording switch is pressed;

FIG. 5 and FIG. 6 are concerned with a second embodiment of the present invention;

FIG. 5 is a flowchart describing the steps of processing to be performed when an image recording switch is pressed in the second embodiment;

FIG. 6 shows a motion image recording confirmation window;

FIG. 7 is a block diagram showing the configuration of an image recording apparatus in accordance with a second embodiment of the present invention;

FIG. 8 to FIG. 11C are concerned with a fourth embodiment of the present invention;

FIG. 8 is a block diagram showing the configuration of an image recording apparatus in accordance with the fourth embodiment of the present invention;

FIG. 9 shows a thumbnail image list screen;

FIG. 10 shows a thumbnail image list screen different from the screen shown in FIG. 9 in terms of a medium use rate indicator;

FIG. 11A to FIG. 11C show examples of reproduction and display of an original image of a thumbnail image;

FIG. 12 to FIG. 14E are concerned with a fifth embodiment of the present invention;

FIG. 12 is a block diagram showing the configuration of an image recording apparatus in accordance with the fifth embodiment;

FIG. 13 shows a menu screen; and

FIG. 14A to FIG. 14E show examples of a menu screen to be displayed when a menu item is selected using a lever switch.

### DESCRIPTION OF THE PREFERRED EMBODIMENTS

(First Embodiment)

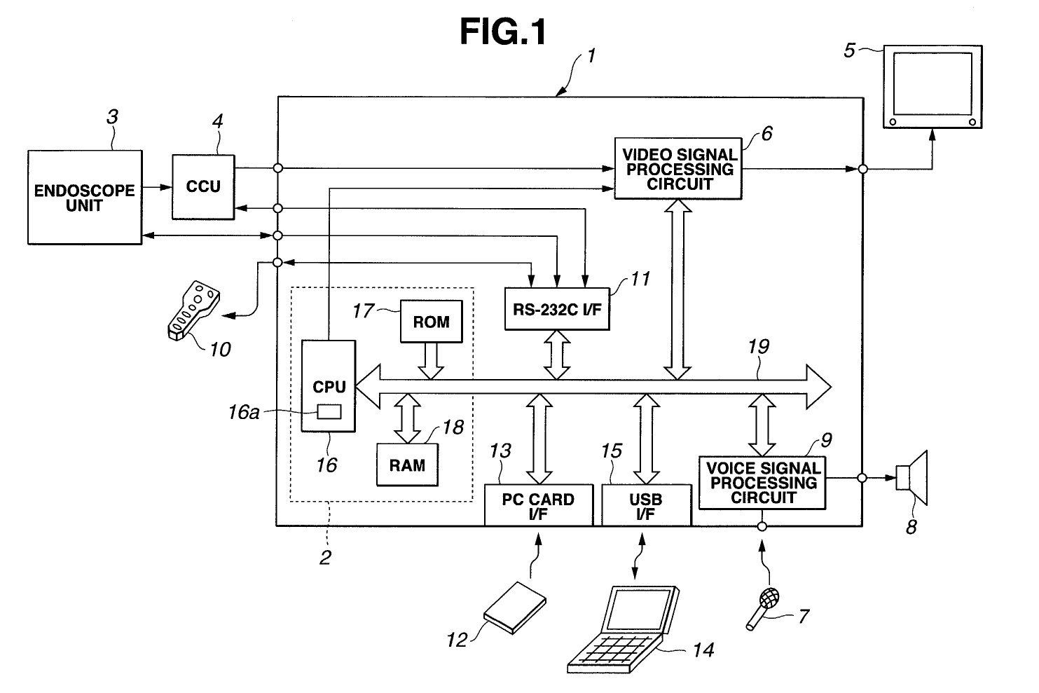

A first embodiment of the present invention will be described with reference to FIG. 1 to FIG. 4.

As shown in FIG. 1, an image recording apparatus 1 in accordance with the first embodiment for recording an endoscopic image consists mainly of a system control unit 2, a video signal processing circuit 6, a voice signal processing circuit 9, an RS-232C interface 11, a PC card interface 13, and a universal serial bus (USB) interface 15. The system control unit 2 controls actions to be performed in the image recording apparatus 1, and controls storage of still image data, motion image(picture) data, and voice data. The video signal processing circuit 6 receives a video signal from a camera control unit (CCU) 4 connected to an endoscope unit 3 through a connector, and transfers the video signal to a video output device (image display device) 5. The voice signal processing circuit 9 receives a voice signal from a voice input unit 7, and transfers the voice signal to a voice output unit 8. Through the RS-232C interface 11, the endoscope unit 3, CCU 4, and remote controller 10 are connected to the image recording apparatus 1, and controlled by performing serial communications. A recording medium, for example, a PC card 12 is loaded in the image recording apparatus through the PC card interface 13 so that the PC card 12 can be freely unloaded, whereby image data or the like is received or transferred to or from the PC card 12. The image recording apparatus 1 is connected to a personal computer 14 through the USB interface 15, whereby the image recording apparatus 1 or endoscope unit 3 is controlled remotely, or image data and voice data are transferred between the personal computer 14 and image recording apparatus 1.

The CCU 4 serving as an image input unit for transferring image data to the image recording apparatus 1 converts an image signal produced by the endoscope unit 3 into a video signal. The CPU 4 then transfers the video signal to the video signal processing circuit 6 in the image recording apparatus 1.

The video signal processing circuit 6 has the ability to transfer the video signal of a motion image sent from the CCU 4, and the ability to transfer a still image temporarily stored in an internal memory. Depending on how the remote controller 10 is manipulated, the video signal processing circuit 6 transfers a motion image or a still image to the image display device 5 under control of the system control unit 2.

Moreover, the video signal processing circuit 6 includes an image recording circuit that compresses and records a motion image or a still image as described later. Therefore, the video signal processing circuit 6 can record either a motion image or a still image in the PC card 12.

The image display device 5 is a display device on which an image represented by an input video signal is displayed, for example, a television monitor or a video projector. The voice input unit 7 is a sound collecting unit, for example, a microphone. The voice output unit 8 is a sounding unit, for example, a loudspeaker.

The system control unit 2 consists mainly of a CPU 16, a ROM 17, and a RAM 18. The CPU 16 is responsible for control of the image recording apparatus 1. Programs to be run by the CPU 16 are stored in the ROM 17. Data necessary for the CPU 16 to run the programs or a program is temporality stored in the RAM 18.

A nonvolatile semiconductor memory such as a flash memory is incorporated in the PC card 12. Image data or any other data stored in the PC card 12 is preserved even after the power supply of the image recording apparatus 1 is turned off.

Moreover, the PC card 12 can be freely loaded or unloaded to or from the image recording apparatus 1 through the PC card interface 13. Image data acquired by the image recording apparatus 1 can be transferred to the personal computer 14.

The recording medium to be employed in the present embodiment is not limited to the PC card 12 that has the capability of a nonvolatile storage. Alternatively, a hard disk drive or a magnetooptical disk drive may be incorporated in the image recording apparatus 1, and image data may be recorded onto a disk loaded in the disk drive.

The video signal processing circuit 6, voice signal processing circuit 9, RS-232C interface 11, PC card interface 13, USB interface 15, CPU 16, ROM 17, and RAM 18 are interconnected over a bus 19, and can transfer digital data among them.

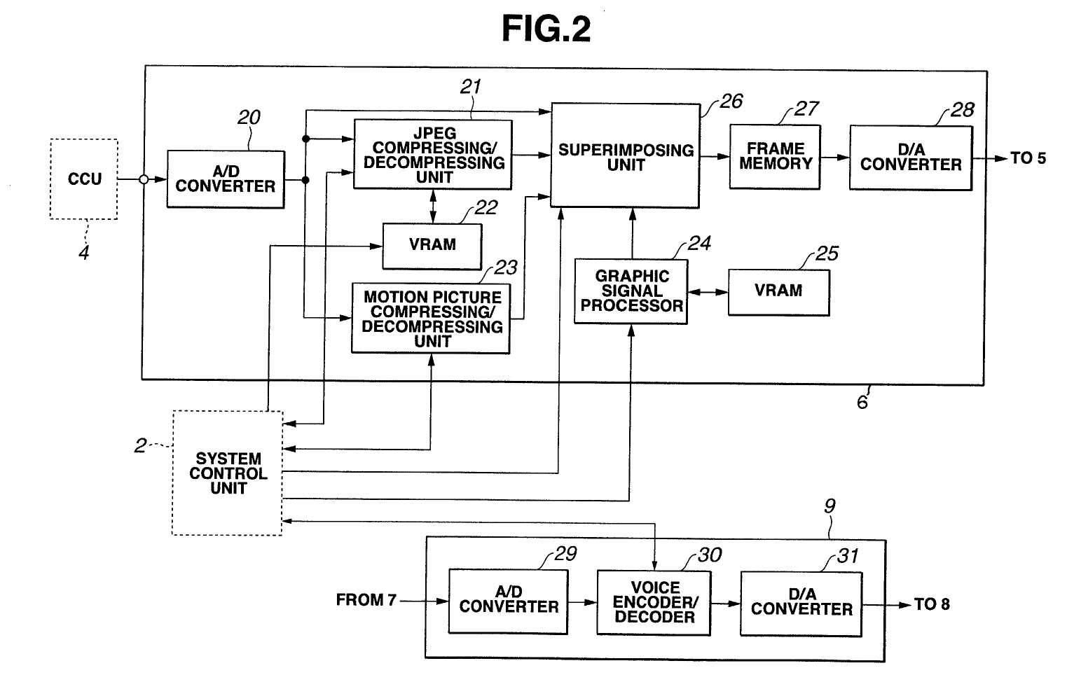

FIG. 2 is a block diagram showing the configurations of the video signal processing circuit 6 and voice signal processing circuit 9.

The video signal processing circuit 6 consists mainly of an A/D converter 20, a JPEG compressing/decompressing unit 21, a video RAM (VRAM) 22, a motion image compressing/decompressing unit 23, a graphic processing unit 24, a VRAM 25, a superimposing unit 26, a frame memory 27, and a D/A converter 28. The A/D converter 20 digitizes a video signal of a motion image sent from the CCU 4. The JPEG compressing/decompressing unit 21 compresses or decompresses still image data. The VRAM 22 is connected to the JPEG compressing/decompressing unit 21, and a still image is temporarily stored in the VRAM 22. The motion image compressing/decompressing unit 23 compresses or decompresses motion image data. The graphic processing unit 24 produces graphic data. The VRAM 25 is connected to the graphic processing unit 24. The superimposing unit 26 superimposes video data digitized by the A/D converter 20 or a video signal sent from the JPEG compressing/decompressing unit 21 or motion image compressing/decompressing unit 23 on graphic data produced by the graphic processing unit 24. A video signal sent from the superimposing unit 26 is temporarily stored in the frame memory 27. The D/A converter 28 converts a video signal read from the frame memory 27 into an analog form.

The superimposing unit 26 receives a video signal of a motion image from the A/D converter 20, or receives a video signal of a still image temporarily stored in the VRAM 22 from the VRAM 22 or via the JPEG compressing/decompressing unit 21. Under control of the system control unit 2, the superimposing unit 26 selects one of the video signals and transfers a selected one to the image display device 5 via the frame memory 27.

The superimposing unit 26 serves as an image signal switching circuit.

The VRAM 22 and VRAM 25 have a storage capacity large enough to store data of at least one frame. The frame memory 27 consists of two memories each having a storage capacity that is large enough to store data of, for example, one frame. While data is stored in one of the memories, data is read from the other memory. The frame memory 27 can therefore cope with recording of a motion image.

The voice signal processing circuit 9 consists of an A/D converter 29 for digitizing a voice signal sent from the voice input unit 7, a voice encoder decoder 30 for encoding or decoding a digital voice signal, and a D/A converter 31 for converting a decoded digital voice signal into an analog form.

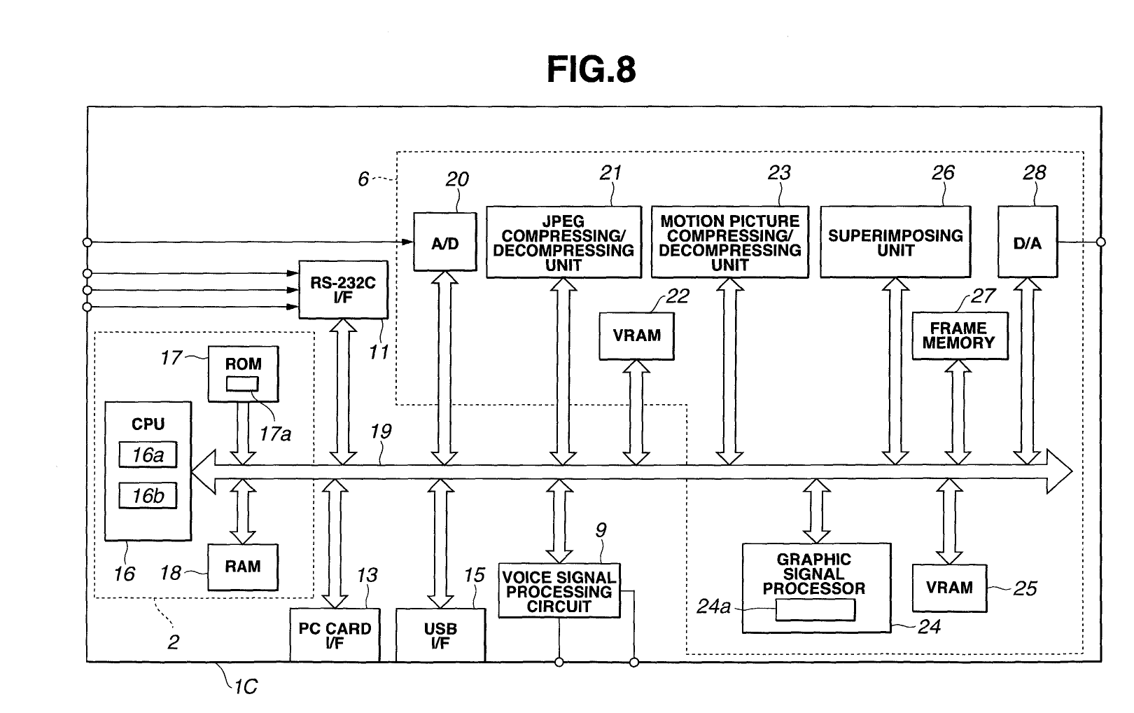

The A/D converter 20 and other circuit elements incorporated in the video signal processing circuit 6 are, as shown in FIG. 8, interconnected over a bus 19, can transfer digital data to or from one another over the bus 19. For example, referring to FIG. 2, the VRAM 22 is connected to the JPEG compressing/decompressing unit 21. An image digitized by the A/D converter 20 can be stored as a still image in the VRAM 22 by way of the bus 19. In FIG. 2, the image digitized by the A/D converter 20 is stored in the VRAM 22 via the JPEG compressing/decompressing unit 21. The CPU 16 incorporated in the system control unit 2 controls writing or reading of data in or from the VRAM 22.

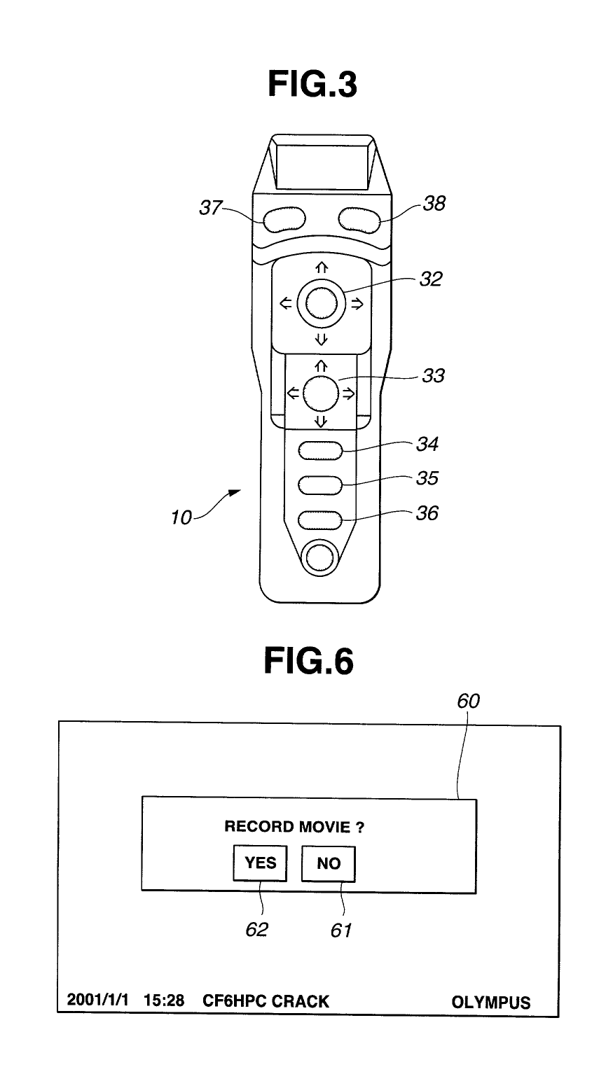

The remote controller 10 employed in the present embodiment has, as shown in FIG. 3, a plurality of switches.

Referring to FIG. 3, the switches of the remote controller 10 include a joystick 32, a lever switch 33, and a plurality of push-button switches 34 to 38. When the joystick 32 is tilted in any direction, inclination information is transmitted. When the joystick 32 is pushed down along the center axis thereof, push information is transmitted. When the lever switch 33 is tilted vertically or laterally, information representing a tilt in each direction is transmitted. When the lever switch 33 is pushed down along the center axis thereof, push information is output. When the push-button switches 34 to 38 are pressed, press information is transmitted.

The push-button switches 34 to 38 include the image recording switch 34, thumbnail display switch 35, mark switch 36, menu switch 37, and freeze switch 38. In other words, an image recording feature, a feature for displaying a thumbnail list screen form, a feature for adding a mark indicator, a feature for displaying a menu, and an image freezing feature are associated with the switches 34 to 38. The press of the switches activates the associated features.

Inclination information sent from the remote controller 10 responsively to tilting of the joystick 32, or press information sent therefrom responsively to a press of any of the push-button switches 34 to 38 is transferred as a control signal to the CPU 16 through the RS-232C interface 11. The CPU 16 controls the image recording apparatus 1 according to a system control program.

For example, when the joystick 32 of the remote controller 10 is tilted in any direction, inclination information is sent to the CPU 16 through the RS-232C interface 11. The CPU 16 transmits an angling control signal, which is used to control angling of the distal part of the insertion member of an endoscope, to the endoscope unit 3 through the RS-232C interface 11. The endoscope unit 3 controls rotation of an angling control motor incorporated therein according to the angling control signal sent from the CPU 16. Consequently, angulation wires running through the insertion member of the endoscope are taken up or stretched in order to thus control angling of the distal part of the insertion member of the endoscope.

When the joystick 32 is pushed down along the center axis thereof, a control signal produced responsively is sent to the CPU 16. The CPU 16 transmits an angling lock signal, which is used to lock angling of the distal part of the insertion member of the endoscope, to the endoscope unit 3 through the RS-232C interface 11. The endoscope unit 3 stops the angling control motor, and locks angling of the distal part of the insertion member of the endoscope.

The lever switch 33 of the remote controller 10 can be tilted in four directions of vertical directions and lateral directions. The lever switch 33 can be pushed down along the center axis thereof. A control signal produced when the lever switch 33 is tilted or pushed down along the center axis thereof is sent to the CPU 16 through the RS-232C interface 11. When the lever switch 33 is tilted or pushed down, the CPU 16 gives control according to the state of the image recording apparatus 1.

When any of the push-button switches 34 to 38 of the remote controller 10 is pressed, a control signal produced responsively is sent to the CPU 16 through the RS-232C interface 11.

When the freeze switch 38 is pressed, the system control unit 2 stores a video signal, which is digitized by the A/D converter 20 incorporated in the video signal processing circuit 6, temporarily in the VRAM 22. At the same time, the system control unit 2 gives control so that a video signal will be read from the VRAM 22 and superimposed on graphic data by the superimposing unit 26. The resultant video signal is then sent to the video output unit 5 via the frame memory 27 and D/A converter 28.

As mentioned above, when the freeze switch 38 is pressed, a video signal temporarily stored in the VRAM 22 is read and sent to the image display unit 5. The image display unit 5 therefore displays a frozen image.

When the freeze switch 38 is pressed, a frozen image is displayed. The CPU 16 incorporated in the system control unit 2 then sets, for example, a freeze display flag, which is reset to 0, to 1, and stores the bit of 1 as displayed image switching information in a register 16a incorporated in the CPU 16. Whether a frozen image or a motion image is selected (freeze is activated or inactivated) can be judged from whether the freeze flag is set to 1.

When the freeze switch 38 is pressed again, the system control unit 2 instructs the superimposing unit 26 to superimpose graphic data on a video signal digitized by the A/D converter 20 incorporated in the video signal processing circuit 6. The resultant signal is then transferred to the video output unit 5 via the frame memory 27 and D/A converter 28. In other words, a video signal of a still image read from the VRAM 22 is switched to a video signal of a motion image sent from the A/D converter 20. This signifies that freeze is inactivated. In this case, the freeze display flag is reset to 0.

When the image recording switch 34 is pressed, the CPU 16 judges from the freeze flag bit whether a currently displayed image is a frozen image or an unfrozen image. If the currently displayed image is a frozen image, the CPU 16 instructs the JPEG compressing/decompressing unit 21, which records a still image, to compress a video signal, which has been temporarily stored in the VRAM 22 for the purpose of recording a still image, according to the JPEG. The resultant signal is recorded onto the PC card 12 through the PC card interface 13.

At this time, a voice signal entered at the voice signal input unit 7 is sent to the voice encoder decoder 30 via the A/D converter 29. The encoded voice signal is appended to the video signal, and the resultant video signal is recorded onto the PC card 12.

Moreover, if the currently displayed image is an unfrozen image, when the image recording switch 34 is pressed, the motion image compressing/decompressing unit 23 that records a motion image compresses a video signal that has been digitized for the purpose of recording a motion image. The resultant signal is recorded onto the PC card 12 through the PC card interface 13.

At this time, if a voice signal is received, similarly to when a still image is displayed, the voice signal is appended to the video signal. The resultant signal is then recorded onto the PC card 12. The storage area in the PC card 12 can be managed while being segmented into a plurality of folders. Before an image is recorded, if a folder is selected, the image can be recorded in the desired folder.

According to the present embodiment, when (or more strictly, immediately before) a manipulation is performed for recording an image in a recording medium, whether an image-displayed state is a motion image-displayed state or a still image-displayed state is judged. An image recording mode is automatically determined based on the result of judgment. Specifically, when a motion image is currently displayed, the motion image is recorded (in a motion image mode). When a still image is currently displayed, the still image is recorded (in a still image mode). Consequently, an image can be recorded properly according to an image-displayed state.

In other words, a motion image sent from an image input means and a still image read from a still image memory means (specifically the VRAM 22) in which the motion image is temporarily stored as a still image are switched in order to display either of the motion image and still image on an image display means. When a manipulation is performed for recording an image in a recording medium, a recording mode in which the image is recorded onto a recording means is automatically determined based on the result of switching.

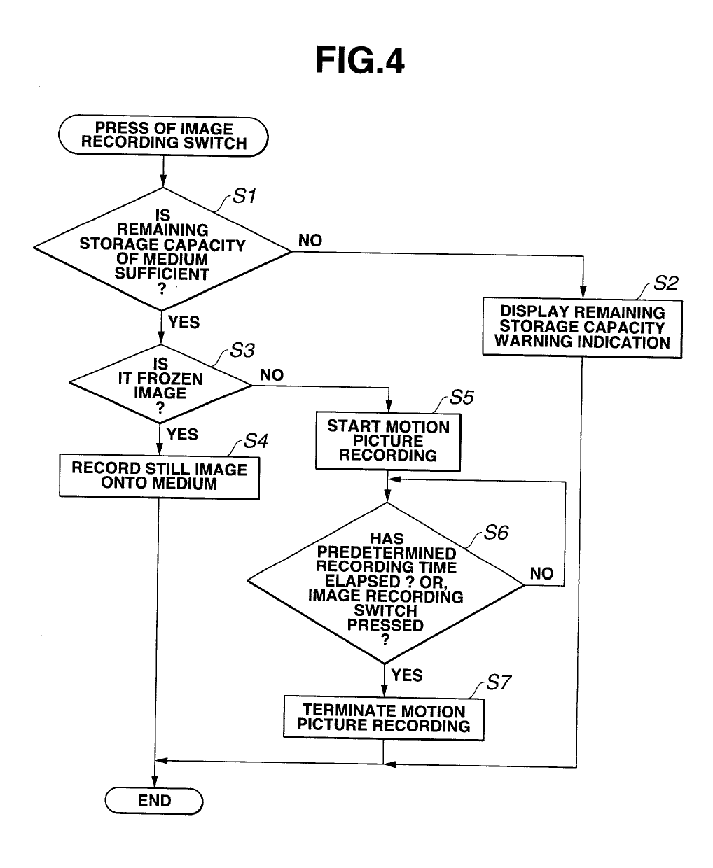

Next, actions to be performed in the present embodiment when a manipulation is performed for recording an image will be described in conjunction with the flowchart of FIG. 4.

When the image recording switch 34 of the remote controller 10 is pressed, the CPU 16 checks at step S1 if the remaining storage capacity of the PC card 12 that is a recording medium is sufficiently large.

If the remaining storage capacity of the PC card 12 is limited, that is, too small to record image data, or if the PC card 12 is not loaded, a remaining storage capacity warning indication is displayed at step S2. Processing is then terminated.

On the other hand, if the remaining storage capacity of the PC card 12 is sufficiently large, it is judged at step S3 whether an image displayed on a display means (image display device 5) is a frozen image. If the image is a frozen image, the image is recorded onto the PC card 12 in the still image recording mode at step S4. Processing is then terminated.

In contrast, if the image is not a frozen image, motion image recording is started at step S5 in order to record a motion image onto the PC card 12. When motion image recording is started, the CPU 16 judges at step S6 whether a predetermined recording time has elapsed or whether the image recording switch 34 of the remote controller 10 has been pressed. If the predetermined recording time has elapsed or the image recording switch 34 has been pressed, motion image recording is terminated at step S7. When motion image recording is terminated, processing is terminated.

According to the present embodiment, the state of an image displayed on the image display device 5 is judged, and an optimal recording mode is automatically selected based on the state of the image displayed. This obviates the necessity of an operator's switching image recording modes.

Moreover, once an operator recognizes the state of an image displayed, the operator becomes aware of in what recording mode an image is recorded. Consequently, occurrence of an incident that an image is recorded in an operator's unintended recording mode can be minimized.

In short, according to the present embodiment, when a manipulation is performed for recording an image, if it is judged from the immediately preceding state of the image that a still image is displayed, the still image is recorded onto a recording medium. If it is judged that a motion image is displayed, the motion image is recorded onto the recording medium. Consequently, an image can be properly recorded based on the state of the image displayed. For example, a still image will not be recorded as a motion image in vein. This results in a user-friendly image recording apparatus.

As described above, for displaying a still image, it is necessary to read an image from an image memory means designed for temporary storage. For displaying a motion image, it is unnecessary to read an image from the image memory means designed for temporary storage. The present embodiment is not limited to this mode. Alternatively, both the motion image and still image may be stored temporarily in a memory means, and then sent to a display means for display.

(Second Embodiment)

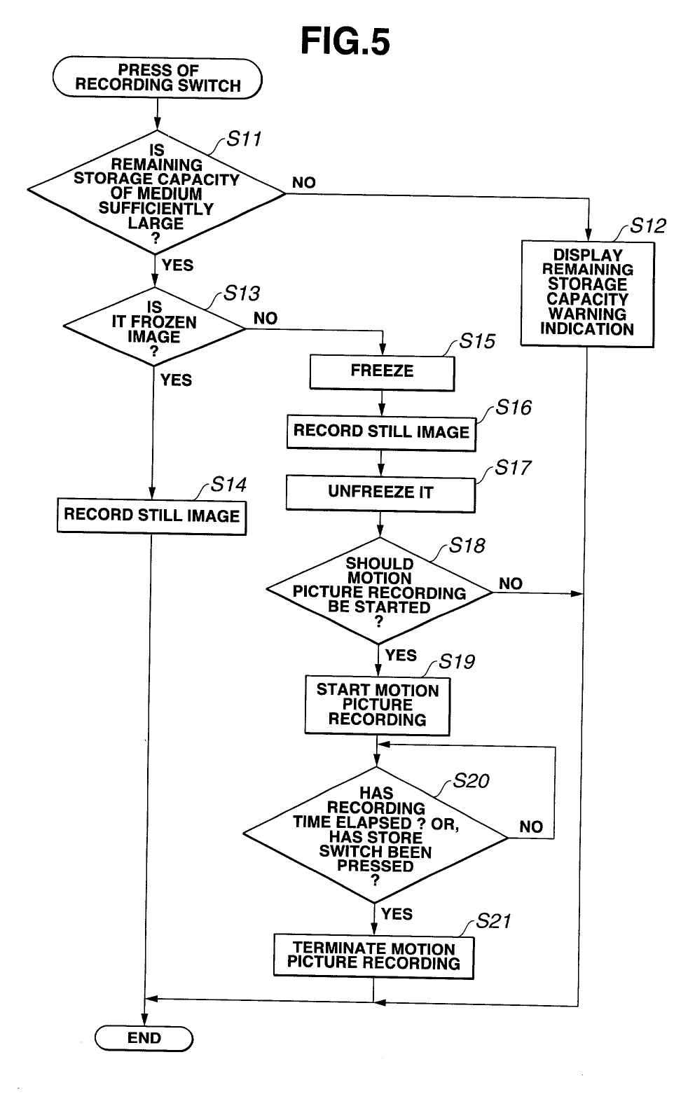

Next, a second embodiment of the present invention will be described with reference to FIG. 5 and FIG. 6. The present embodiment has the same configuration as the first embodiment. However, action programs are partly different.

Actions to be performed in the present embodiment will be described in conjunction with the flowchart of FIG. 5.

When the image recording switch 34 of the remote controller 10 is pressed, it is checked at step S11 if the remaining storage capacity of a recording medium is sufficiently large.

If the remaining storage capacity of a recording medium is too small to record image data, or if no recording medium is loaded, a remaining storage capacity warning indication is displayed at step S12. Processing is then terminated.

On the other hand, if the remaining storage capacity of the recording medium is sufficiently large, it is judged at step S13 whether an image displayed on the display means is a frozen image.

If the image is a frozen image, a still image is recorded onto the recording medium at step S14. Processing is then terminated.

If the image is not a frozen image but a motion image, images to be displayed are frozen (step S15). The frozen still images are recorded onto the recording medium (step S16), and then unfrozen in order to display a motion image (step S17).

A motion image recording confirmation window 60 like the one shown in FIG. 6 is displayed in order to check at step S18 if motion image recording should be started.

If a No button 61 is selected, motion image recording is suspended and processing is terminated. In contrast, if a Yes button 62 is selected, recording a motion image in the recording medium is started at step S19.

When motion image recording is started, a wait state is retained at step S20 until a predetermined recording time has elapsed or until the image recording switch 34 of the remote controller 10 or a Store switch that is not shown has been pressed again. If the predetermined recording time has elapsed or the image recording switch 34 has been pressed again, motion image recording is terminated at step S21 and processing is terminated.

According to the present embodiment, even when an image is not frozen, the image is frozen once in order to record a still image in a recording medium. Even when a displayed image is an unfrozen image, if an operator wants to record a still image, the operator will not be bothered with the labor of freezing an image. This leads to improved maneuverability. Moreover, a motion image can be recorded.

(Third Embodiment)

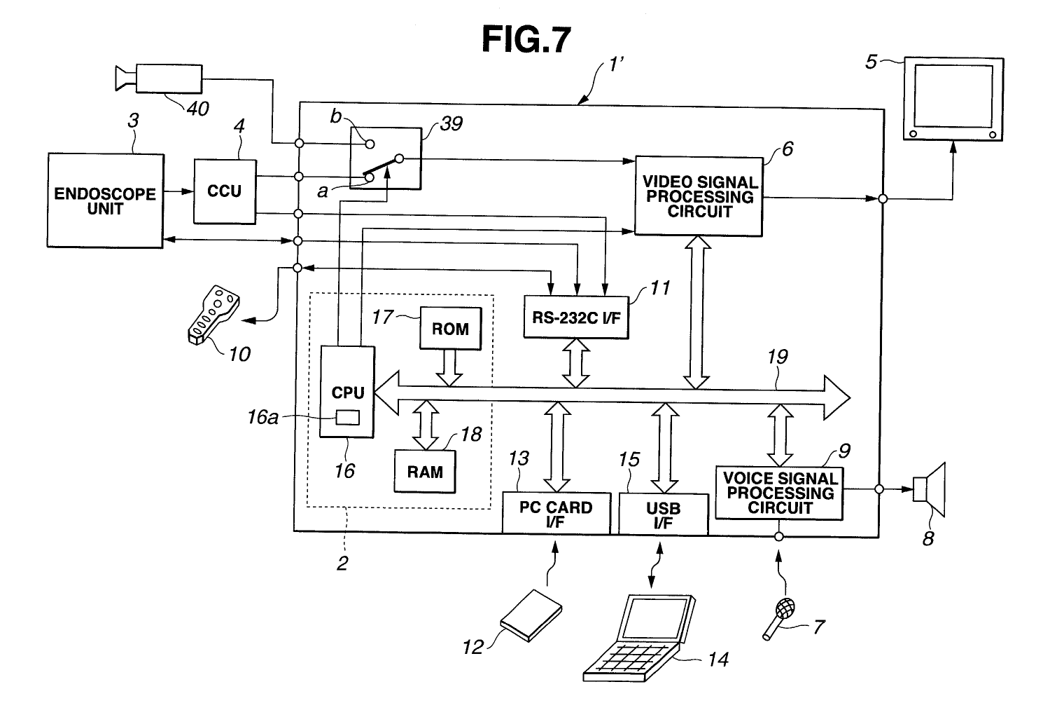

A third embodiment of the present invention will be described with reference to FIG. 7. An image recording apparatus 1′ in accordance with the third embodiment shown in FIG. 7 is different from the image recording apparatus 1 shown in FIG. 1 in a point that an image switching unit 39 is interposed between the CCU 4 and video signal processing circuit 6. An image signal sent from the CCU 4 is applied to one input terminal a of the image switching unit 39.

An image signal sent from an external video input unit 40 is applied to the other input terminal b of the image switching unit 39 through an external input terminal. An image signal passed through the image switching unit 39 is sent to the video signal processing circuit 6.

Switching the input terminals of the image switching unit 39 is controlled by the CPU 16 incorporated in the system control unit 2. Specifically, the CPU 16 switches the input terminals responsively to a manipulation performed on the remote controller 10.

Normally, the input terminal of the image switching unit 39 is selected for providing the connection to the CCU 4. An endoscopic image is sent to the video signal processing circuit 6.

The input terminals of the mage switching unit 39 are switched responsively to a manipulation performed on the remote controller 10. Consequently, a video signal sent from the video input unit 40 connected through an external input terminal is transferred to the video signal processing circuit 6.

The other components of the present embodiment and the operation thereof are identical to those of the first embodiment.

The image recording apparatus 1′ of the present invention can provide the same advantages as the first embodiment. In addition, not only an endoscopic image but also an image transferred from outside can be displayed or recorded.

For example, an imaging device such as a CCD camera may be connected through the external input terminal. In this case, the appearance of an object of inspection that can hardly be imaged using an endoscope or an ambient situation of a site at which an endoscopic inspection is carried out can be imaged and recorded. If an inspection is reviewed later, in what situation the inspection was performed can be recognized from the recorded image. This will help analyze the results of inspection. The other advantages are identical to those of the first embodiment.

The remote controller 10 may not be used in order to switch the input terminals of the image switching unit 39. Instead, when it is sensed that a video signal sent from the video input unit 40 is applied to the external input terminal, the input terminals of the image switching unit 39 may be automatically switched in order to provide the connection to the external input terminal.

(Fourth Embodiment)

Next, a fourth embodiment of the present invention will be described with reference to FIG. 8 to FIG. 11C. The configuration of an image recording apparatus in accordance with the present embodiment is nearly the same as the configuration of the image recording apparatus shown in FIG. 1. However, action programs are partly different.

An image recording apparatus 1C shown in FIG. 8 is different from the image recording apparatus shown in FIG. 1 or FIG. 2 in a point that a thumbnail image display program 17a is stored in the ROM 17 included in the system control unit 2.

When the thumbnail display switch 35 of the remote controller 10 is pressed, the CPU 16 follows the thumbnail image display program 17a. Specifically, the CPU 16 instructs the JPEG compressing/decompressing unit 21 to decompress a plurality of image data items recorded on folders of the PC card 12. The decompressed images are thinned out and reduced in size to produce thumbnail images, and the thumbnail images are successively stored in, for example, the VRAM 22.

The superimposing unit 26 superimposes the plurality of thumbnail images successively stored in the VRAM 22 on images produced by the graphic signal processor 24. The resultant images are stored in the frame memory 27, and then transferred to the image display device 5.

When recorded image data represents a motion image, the first set of images contained the motion image is decompressed by the motion image compressing/decompressing unit 23. The decompressed images are thinned out and reduced in size to produce thumbnail images. The thumbnail images are then stored in the VRAM 22.

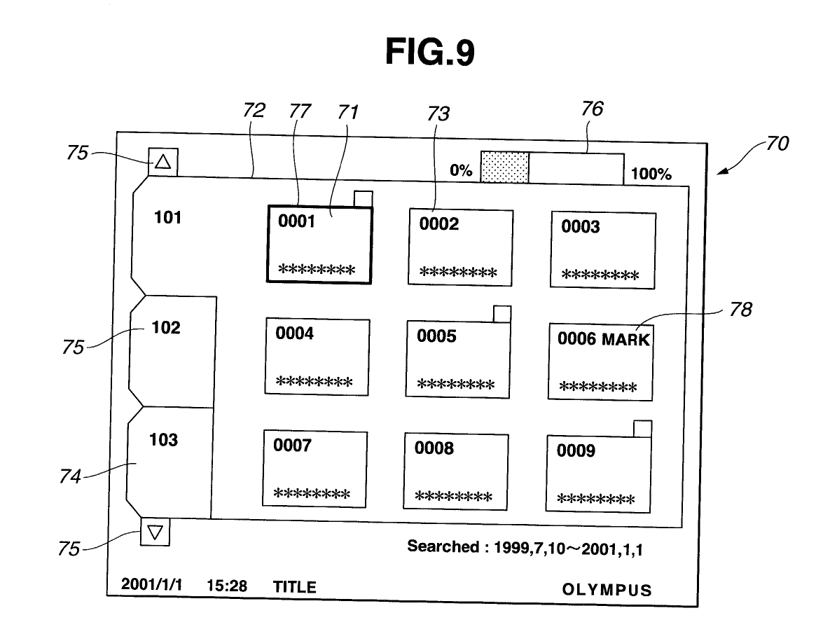

As shown in FIG. 9, the plurality of thumbnail images is listed in a thumbnail image list screen form 70.

Moreover, the graphic signal processor 24 produces graphic images other than the thumbnail images. For example, the graphic signal processor 24 includes an image designation mark producing unit 24a that produces an image designation mark (cursor) which points out one designated thumbnail image.

The superimposing unit 26 superimposes the thumbnail images on the graphic images. The resultant images are displayed on the image display device 5 via the frame memory 27.

Next, a description will be made of actions that are performed in the present embodiment and different from those in the first embodiment.

To begin with, actions to be performed responsively to a manipulation performed for reproducing an image will be described in conjunction with FIG. 9.

When the thumbnail display switch 35 of the remote controller 10 is pressed, an instruction issued responsively to a manipulation performed for viewing recorded image data is given to the system control unit 2. The CPU 16 gives control to transfer the plurality of images recorded on the folders of the PC card 12 to the JPEG compressing/decompressing unit 21.

Thumbnail images produced by decompressing and reducing in size the images are superimposed on a display sheet 72 produced by the graphic signal processor 24. The resultant images are stored in the frame memory 27. The images stored in the frame memory 27 are read, and the thumbnail image list screen form 70 shown in FIG. 9 is displayed on the image display device 5.

The plurality of thumbnail images 71 bearing file name serial numbers 73 is displayed in the thumbnail image display sheet 72 within the thumbnail image list screen form 70. The thumbnail images 71 are based on original images. What are displayed as the thumbnail images are images produced by reducing in size the original images.

For recording an image onto the PC card 12, the CPU 16 detects via the PC card interface 13 a storage capacity occupied by stored images or a remaining storage capacity available for storage of images from a storage capacity the PC card 12 can offer by nature. The CPU 16 then stores the information in an internal register 16b. After images are stored, previous information is updated. When images are read, a medium use rate may be indicated using a medium use rate indicator as described later.

The storage area in the PC card 12 may be managed while being segmented into a plurality of folders. A folder tab 74 shown in FIG. 9 is assigned to an associated folder in the PC card 12. In FIG. 9, three folder tabs 74 bearing folder numbers 75 of 101, 102, and 103 are displayed. When the folders are thus created in order to manage images neatly, the images can be managed easily.

When many folders are defined in the PC card 12, all folder tabs 74 assigned to the folders may not be able to be displayed within the screen form. In this case, folder scroll indicators 75 are displayed at upper and lower points within the screen form in order to indicate that folders are present in addition to those appearing within the screen form.

A medium use rate indicator 76 is displayed within the thumbnail image list screen form 70. The use rate of the PC card 12 is indicated in the form of a bar graph so that the remaining storage capacity can be identified at sight. Consequently, since the remaining storage capacity of the PC card 12 can be thus identified, an incident that an operator remains unaware of the fact that the PC card 12 becomes full during an inspection can be avoided.

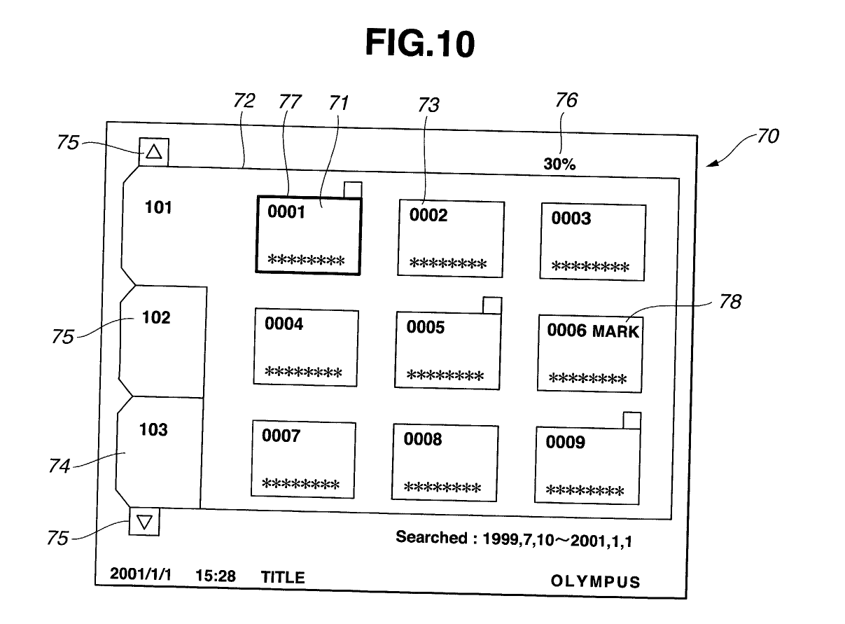

The medium use rate indicator 76 may be, as shown in FIG. 10, a numerical value representing the percentage of the use rate of a medium.

The lever switch 33 of the remote controller 10 is tilted vertically or laterally, whereby any one thumbnail image can be designated from among the plurality of thumbnail images 71 displayed.

The designated thumbnail image can be distinguished from the other thumbnail images when being hemmed using a thumbnail image designation cursor 77.

After one thumbnail image 71 is selected, if a manipulation is performed for reproducing an image as described later, the original image of the thumbnail image 71 is reproduced. Moreover, after one thumbnail image or a plurality of thumbnail images 71 is selected, if copy, movement, or deletion is executed, the original image of the thumbnail image 71 is copied, moved, or deleted.

When a thumbnail image 71 is selected by vertically or laterally tilting the lever switch 33 of the remote controller 10, if the mark switch 36 is pressed, a mark indicator 78 is appended to the thumbnail image 71.

The mark indicator 78 can be appended to a plurality of thumbnail images 71.

By appending the mark indicator 78 to the thumbnail image 71, copy, movement, or deletion can be executed for the marked image.

A manipulation performed for reproducing an image is a manipulation performed on the switch of the remote controller 10. Specifically, the lever switch 33 of the remote controller 10 is pushed down with one thumbnail image 71 designated within the thumbnail image list screen form 70. The original image of the designated thumbnail image 71 is then reproduced. At this time, if the original image of the designated thumbnail image 71 is a still image, the still image is displayed entirely on the screen of the display device.

If the original image of the designated thumbnail image 71 is a motion image, motion image reproduction is started.

If the original image of the designated thumbnail image 71 has voice appended thereto, original image reproduction as well as voice reproduction is started.

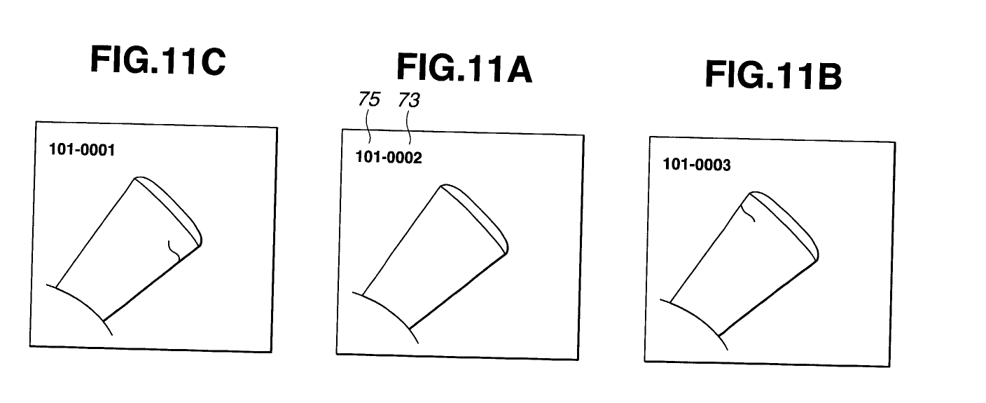

When an image is reproduced, the image associated with the thumbnail image 71 is, as shown in FIG. 11A, displayed entirely on the screen of the display device. The folder number 75 and image serial number 73 are indicated successively on the screen. FIG. 11A shows a reproduced image having a serial number of 0002 and being stored in a folder of No. 101.

When the lever switch 33 is pushed down with an image reproduced, the thumbnail image list screen form 70 reappears.

When the lever switch 33 of the remote controller 10 is tilted laterally with an image reproduced, images in the same folder can be successively switched and reproduced without the necessity of re-displaying the thumbnail image list screen form 70. When the lever switch 33 is tilted rightward, an image to be reproduced is switched to a succeeding image. When an image is switched to a succeeding image, an image whose image serial number 73 is larger by one is, as shown in FIG. 11B, reproduced.

When the lever switch 33 is tilted leftward, an image to be reproduced is switched to a preceding image. When an image is switched to a preceding image, an image whose image serial number 73 is smaller by one is, as shown in FIG. 11C, reproduced.

According to the present invention, when the lever switch 33 is tilted laterally with an image reproduced and displayed, preceding and succeeding images can be switched and displayed. When images must be successively reproduced, it is unnecessary to re-display the thumbnail image list screen form 70 and resume the manipulation for reproducing an image.

Even when numerous images are recorded during one inspection, an operator is relieved of the labor of performing manipulations for reproducing images so as to review the results of inspection. A desired image can be reproduced readily. The other advantages are identical to those of the first embodiment.

(Fifth Embodiment)

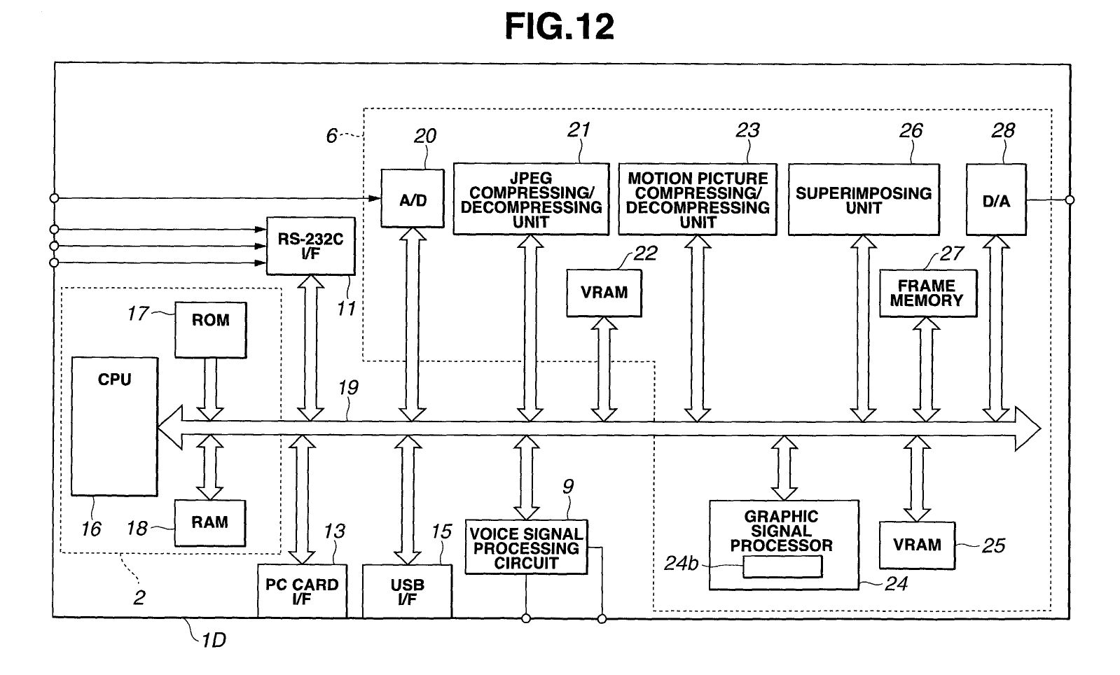

Next, a fifth embodiment of the present invention will be described with reference to FIG. 12 to FIG. 14E. The configuration of an image recording apparatus in accordance with the present embodiment is nearly the same as that of the image recording apparatus shown in FIG. 1 or FIG. 8.

An image recording apparatus 1D shown in FIG. 12 is different from the image recording apparatus shown in, for example, FIG. 8 in a point that the graphic signal processor 24 includes a menu screen form producing unit 24b for producing a menu screen form. When the menu switch 37 shown in FIG. 3 is pressed, the CPU 16 issues a menu screen form production command to the graphic signal processor 24. In the graphic signal processor 24, the menu screen form producing unit 24b produces a menu screen form and stores it in the frame memory 27. The menu screen form stored in the frame memory 27 is transferred to the image display device 5. The other components are nearly identical to those shown in FIG. 8.

Next, actions inherent to the present embodiment will be described below.

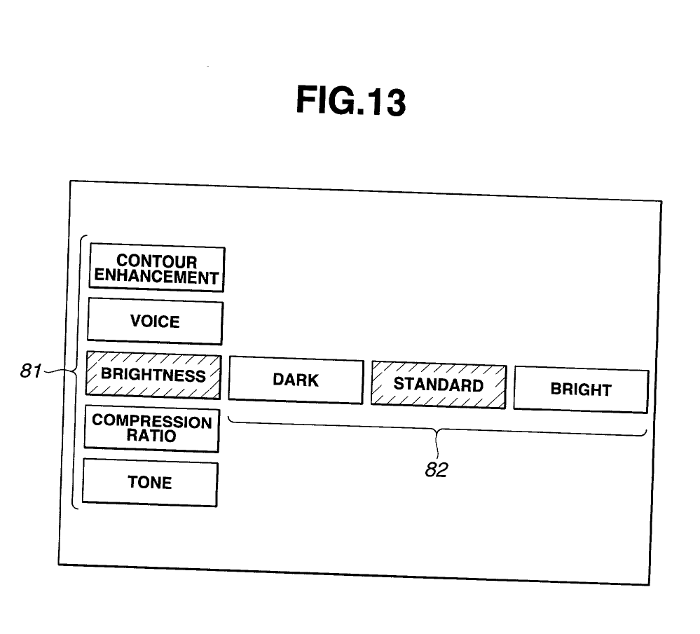

In the present embodiment, the menu switch 37 of the remote controller 10 shown in FIG. 3 is a switch used to display an onscreen menu on the screen of the image display device 5. When the menu switch 37 is pressed, a menu screen form 80 shown in FIG. 13 appears.

The lever switch 33 can be tilted in four directions of vertical directions and lateral directions. When the lever switch 33 is tilted vertically with the menu screen form displayed, a menu item can be selected. When the lever switch 33 is tilted laterally, a set item can be selected.

Referring to FIG. 13, a menu employed in the present embodiment will be described. When the menu switch 37 of the remote controller 10 is pressed, the system control unit 2 displays the menu screen form 80 shown in FIG. 13 on the screen of the image display device 5. Within the menu screen form 80, menu items 81 are presented lengthwise as shown in FIG. 13.

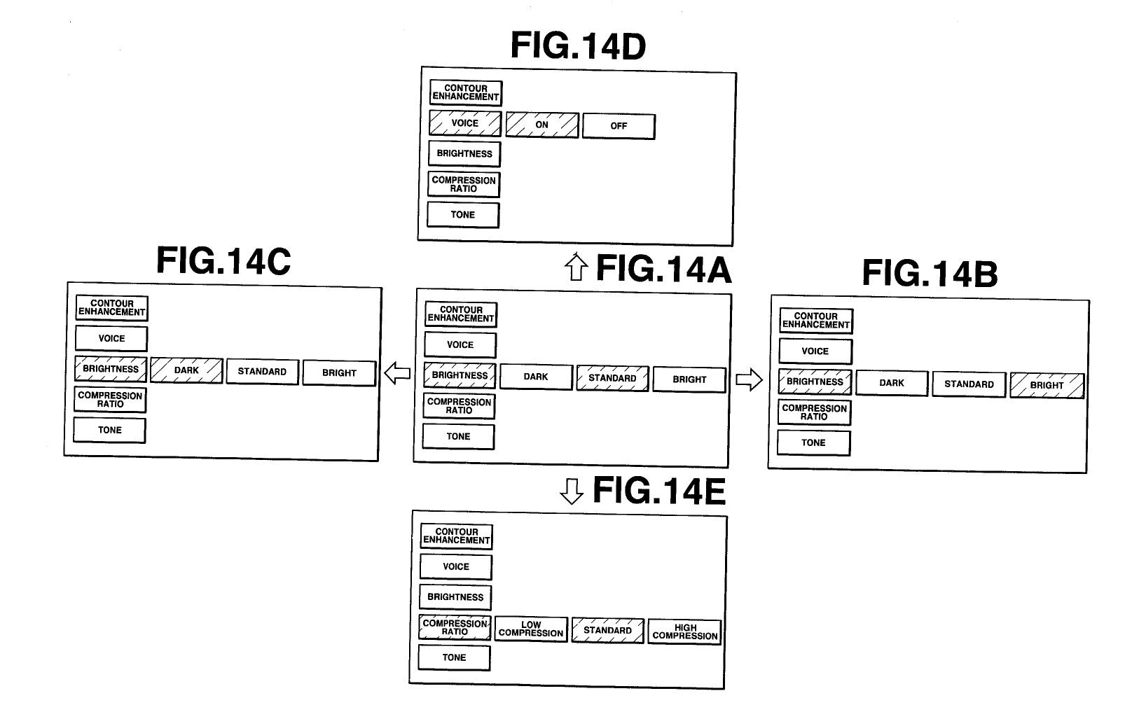

According to the present embodiment, the menu items 81 include Contour Enhancement, Voice, Brightness, Compression Ratio, and Tone that are arranged in that order. The system control unit 2 presents the menu items 81, and selects one of the menu items 81 without fail. At this time, the selected menu item 81 is highlighted (hatched in FIG. 13, and FIG. 14A to FIG. 14E) in order to explicitly indicate that the menu item 81 is selected. In FIG. 13, the menu item 81 of brightness is selected.

The system control unit 2 presents set items 82 associated with the selected menu item 81 on the right-hand side of the menu item 81. In the present embodiment, the set items 82 associated with the menu item 81 of brightness include Dark, Standard, and Bright that are arranged in that order from left to right.

The system control unit 2 presents the set items 82, and selects one of the set items 82 without fail. At this time, the selected set item 82 is highlighted (hatched in FIG. 13, and FIG. 14A to FIG. 14E) in order to explicitly indicate that the set item 82 is selected. In FIG. 13, Standard is selected as the set item 82 for the menu item of brightness.

Next, actions to be performed with the menu displayed in the present embodiment will be described in conjunction with FIG. 14A to FIG. 14E.

To begin with, a description will be made of actions to be performed when the lever switch 33 is tilted laterally. As shown in FIG. 14A, the menu item 81 of brightness and the set item 82 of standard are selected. In this state, when the lever switch 33 is tilted rightward, the system control unit 2 changes the selected set item to the right-hand set item of bright as shown in FIG. 14B.

Accordingly, the set item 82 of bright is highlighted instead of the set item 82 of standard. When the set item 82 has no set item present on the right-hand side thereof, the set item 82 is not changed. Likewise, when the lever switch 33 is tilted leftward with the menu item 81 of brightness and the set item 82 of standard selected, the system control unit 2 changes the selected set item 82 to the left-hand set item of dark as shown in FIG. 14C.

Accordingly, the set item 82 of dark is highlighted instead of the set item 82 of standard. When the set item 82 has no set item present on the left-hand side thereof, the set item 82 is not changed. When the set item 82 is changed to another, the system control unit 2 promptly executes a feature associated with the selected set item 82.

Incidentally, the menu item 81 of brightness is associated with a feature for setting the brightness of an image. As shown in FIG. 14B, when the set item for the menu item 81 of brightness is changed from Standard to Brightness, the CCU 4 is controlled so that an image will become immediately brighter.

Next, a description will be made of actions to be performed when the lever switch 33 is tilted vertically.

When the menu item 81 of brightness is selected as shown in FIG. 14A, if the lever switch 33 is tilted upward, the system control unit 2 changes the selected menu item 81 to the upper menu item of voice as shown in FIG. 14D.

The menu item 81 of voice is then highlighted instead of the menu item 81 of brightness. When the menu item 81 is changed to Voice, the set items 82 for Brightness, that is, Dark, Standard, and Bright are deleted at the same time. Consequently, the set items 82 for Voice, that is, On and Off are presented as shown in FIG. 14D.

Likewise, when the lever switch 33 is tilted downward with the menu item 81 of brightness selected, the system control unit 2 changes the selected menu item 81 to the lower menu item of compression ratio as shown in FIG. 14E. The menu item of compression ratio is then highlighted instead of the menu item of brightness.

When the menu item 81 is changed to Compression Ratio, the set items 82 for Brightness, that is, Dark, Standard, and Bright are deleted at the same time. Consequently, the set items for Compression Ratio, that is, Low Compression, Standard, and High Compression are presented as shown in FIG. 14E.

The present embodiment provides the same advantages as the first embodiment. In addition, a desired menu item or the like can be selected and finalized easily and quickly.

When no menu is displayed, the lever switch 33 may be used to instruct any processing other than selection of the menu item 81.

For example, when a zooming feature or the like is used to magnify an image, the lever switch 33 may be used to instruct vertical or lateral movement of an image (tilting or panning). In this case, the lever switch 33 can be tilted not only vertically and laterally but also obliquely.

This leads to a decreased number of switches and improved maneuverability.

Having described the preferred embodiments of the invention referring to the accompanying drawings, it is to be understood that the invention is not limited to those precise embodiments and that various changes and modifications thereof could be effected by one skilled in the art without departing from the spirit or scope of the invention as defined in the appended claims.

What is claimed is:

1. An image recording apparatus comprising:
a connector through which a motion image is inputted;
a memory in which an image of a motion image inputted through the connector, which constructs one frame, is stored as a still image;
a display device on which an image is displayed;
an image signal switching circuit for switching a motion image inputted through the connector and a still image read from the memory, and outputting a selected one to the display device;
a remote controller for instructing start of image recording;
a recording processing circuit for recording a displayed image onto a predetermined recording medium according to the state of the image signal switching circuit that performs switching; and
a recording control circuit for, when the remote controller instructs image recording, setting a recording mode of the recording processing circuit according to the state of the image signal switching circuit.

2. An image recording apparatus according to claim 1, wherein when an image displayed on the display device is a still image, if the remote controller instructs image recording, the recording control circuit sets a still image recording mode for the recording processing circuit.

3. An image recording apparatus according to claim 1, wherein when an image displayed on the display apparatus is a motion image, if the remote controller instructs image recording, the recording control circuit sets a motion image recording mode for the recording processing circuit.

4. An image recording apparatus according to claim 1, wherein: the recording control circuit includes an information memory in which information indicating whether an image outputted to the display device via the image signal switching circuit is a still image or a motion image is stored; and the recording control circuit automatically determines a recording mode of the recording processing circuit by referring information stored in the information memory when the remote controller instructs image recording.

5. An image recording apparatus according to claim 1, wherein: the recording processing circuit includes a motion image compressing processing circuit that compresses a motion image, and a still image compressing processing circuit that compresses a still image; and the recording processing circuit compresses the motion image or still image according to a recording mode set by the recording control circuit.

6. An image recording apparatus according to claim 1, wherein when the remote controller instructs start of image recording, the recording control circuit instructs updating of a still image stored in the memory according to the state of the image signal switching circuit, and instructs the recording circuit to record the still image updated.

7. An image recording apparatus according to claim 1, further comprising a second connector, through which a motion image is inputted, in addition to the connector, and an input switching circuit that switches a motion image received through the connector and a motion image received through the second connector.

8. An image recording apparatus according to claim 1, further comprising a thumbnail image producing unit that produces thumbnail images according to a plurality of images recorded on the recording medium.

9. An image recording apparatus according to claim 1, further comprising a graphic processor for producing graphic image data in response to an instruction from the recording control circuit, wherein the image signal switching circuit outputs graphic image data generated in the graphic processor to the display device.

10. An image recording apparatus according to claim 8, further comprising a graphic processor that displays an image designation mark on a thumbnail image in response to an instruction from the remote controller.

11. An image recording apparatus according to claim 9, wherein the graphic processor produces a menu screen to adjust a displayed image, and the remote controller includes a switch that instructs display of the menu screen, and a lever switch that selects the display item corresponding to arrangement of a display item in the menu screen.

12. An image recording apparatus according to claim 1, further comprising a reproducing processing circuit for reading an image recorded on the recording medium to display the read image on the display device.

13. An image recording apparatus according to claim 1, wherein when an image recorded on the recording medium is a compressed image, the reproducing processing circuit reads the image from the recording medium to decompress the image.

14. An image recording apparatus according to claim 1, further comprising a voice recording processing circuit that records a voice signal.

15. An image recording apparatus according to claim 1, wherein the remaining storage capacity of the recording medium, which is available for storage of information, is detected to be indicated.

16. An image recording apparatus comprising:
an image selecting circuit for selecting either of a motion image and a still image that are outputted;
a display device on which a motion image or a still image selected by the image selecting circuit is displayed;
a remote controller for use in instructing start of image recording;
a recording processing circuit for recording a motion image or a still image;
an image recording medium onto which an image is recorded by the recording processing circuit;
a recording control circuit for, when image recording from the remote controller is instructed, controlling to determine a recording mode, in which one of a motion image and a still image is recorded by the recording circuit, responsively to selection state of the image selecting circuit.

17. An image recording apparatus according to claim 16, wherein when an image displayed on the display device by the image selecting circuit is a still image, if an instruction for start of image recording is made by the remote controller, the recording control circuit controls the recording circuit so that the recording circuit will record the still image.

18. An image recording apparatus according to claim 16, wherein when an image displayed on the display device by the image selecting circuit is a motion image, if an instruction for start of image recording is made by the remote controller, the recording control circuit controls the recording circuit so that the recording circuit will record the motion image.

19. An image recording apparatus according to claim 16, further comprising a still image producing circuit that produces a still image from a motion image, wherein the motion image and the still image produced by the still image producing circuit are outputted to the image selecting circuit.

20. An image recording apparatus according to claim 16, wherein the still image producing circuit is comprised of a memory in which a still image constructing one frame is stored.

21. An image recording method to be implemented in an image recording apparatus that freezes an input image signal to output the resultant signal to a display device, comprising:
a recording starting step of instructing start of image recording;
a displayed state judging step of judging the state of an image displayed on the display device;
a recording mode setting step of setting a recording mode according to the result of judgment at the displayed state judging step; and
a recording processing step of recording an image displayed on the display device onto a predetermined recording medium according to the result of setting at the recording mode setting step.

22. An image recording method according to claim 21, wherein: if a displayed image is judged to be a still image at the displayed state judging step, a mode is set to a recording mode to record a still image at the recording step; and if the displayed image is judged to be a motion image at the displayed state judging step, a mode is set to the recording mode to record a motion image at the recording processing step.

23. An image recording method according to claim 21, further comprising a still image updating step of, when a displayed image is judged to be a motion image at the displayed state judging step, updating a still image, and a still image recording step of recording the still image updated.

24. An image recording method to be implemented in an image recording apparatus having the ability to select one of a motion image and a still image selected by an image selecting circuit to output the selected image to a display device, the image recording method comprising:
a recording starting step of instructing start of image recording;
a displayed image judging step of judging whether an image selected by the image selecting circuit and displayed on the display device is a still image or a motion image;
a recording mode setting step of automatically setting a recording mode, in which one of a still image and a motion image is recorded, according to the result of judgment at the displayed image judging step; and
a recording processing step of recording a still image or a motion image displayed on the display device onto a recording medium according to the result of setting at the recording mode setting step.
